(19) United States
(12) Patent Application Publication
(10) Pub. No.: US 2026/0156395 A1
(43) Pub. Date: Jun. 4, 2026

(54) A HEARING DEVICE

(71) Applicant: GN AUDIO A/S, Ballerup (DK)

(72) Inventors: Chokko CHEN, Ballerup (DK); Samuel GAO, Ballerup (DK); Frank LIN, Ballerup (DK); Arthur YOU, Ballerup (DK); Jack ZHAO, Ballerup (DK); Peter ZHONG, Ballerup (DK); Jon Grane MADSEN, Ballerup (DK); Rasmus PEDERSEN, Ballerup (DK)

(21) Appl. No.: 19/129,910

(22) PCT Filed: Mar. 27, 2023
(86) PCT No.: PCT/CN2023/084152

§ 371 Date: May 14, 2025

(51) Int. Cl. H04R 1/10; H04R 1/1025

(52) U.S. Cl. CPC H04R 1/1008; H04R 1/1025; H04R 1/1066

(57) ABSTRACT

Disclosed is a hearing. The hearing device comprises an ear cup. The hearing device further comprises a headband being configured to rest on the user's head and a hinge arm. The hinge arm comprises a hinge center arranged at the earcup defining a rotating axis of the ear cup with respect to the headband, whereby the hinge arm can rotate through an angular interval from a rest position to a variable use position. The hearing device further comprises a force element configured to bias the hinge arm towards the rest position. The hinge center is arranged offset from a center of the ear cup. The rotating axis is configured to pass through the center of the ear cup.

### FIELD

The present invention relates to hearing devices. More specifically, the disclosure relates to a hearing device comprising an ear cup, a headband, and a hinge arm.

### BACKGROUND

During last years, hearing devices such as over-the-ear and on-the-ear hearing devices have developed significantly e.g. in terms of device performance and size reduction. Such hearing devices typically comprise a pair of earpieces that are connected to each other by an earpiece support. The earpiece support is typically connected to each earpiece via a rotating hinge. Each rotating hinge is typically connected to a center of the earpiece to provide a balanced pressure on an ear of a user of the hearing device, when the user is wearing the hearing device. Providing such balanced pressure is of great importance, as otherwise the user of the hearing device may find wearing the hearing device uncomfortable or even painful, especially when the user wears the hearing device for a long period of time.

However, by arranging the rotating hinge in the center of the earpiece, to provide the required balanced pressure, the rotating hinge occupies a significant portion of a limited space in the centre of the earpiece. The limited space in the centre of the earpiece is of great importance for further development of the hearing device, especially considering the size reduction trend of the hearing devices. Thus, there is a need to provide an improved hearing device to address the abovementioned problems.

### SUMMARY

In conventional hearing devices, the rotating hinge is typically connected to the center of the earpiece to provide the balanced pressure on the ear of the user of the hearing device, when the user is wearing the hearing device. However, such arrangement of the rotating hinge occupies a significant portion of the limited space in the centre of the earpiece. Thus, there may not be enough room in the centre of the earpiece to arrange e.g. a rechargeable battery therein.

One solution may be to increase a size of the earpiece to provide such room. However, increasing the size of the earpiece may not be desired and may affect stability of the earpiece, especially when being arranged on a charging pad. Also, by increasing the size of the earpiece, the earpiece may not be compatible with some interface standards for wireless power transfer.

Another solution may be to arrange the rotating hinge away from the centre of the earpiece. However, if a rotating axis of the rotating hinge does not pass through the centre of the earpiece, the hearing device may not provide the required balanced pressure, when the user is wearing the hearing device. Also, by arranging the rotating hinge away from the centre of the earpiece, the rotating hinge may bulge on an outer surface of the earpiece and thus the earpiece may not be compatible for being wirelessly charged. Therefore, there is a need to provide an improved hearing device to address the abovementioned problems.

In addition, in the conventional hearing devices, when the hearing device is in a rest position, the hearing device may not be stable. This is because a torque may be created due to a center of gravity of the earpiece support, being arranged at one side of the earpiece, and the earpiece itself. The torque may apply a force on the hearing device and the hearing device may thus not maintain its position in a stable manner.

It is an object of the invention to provide an improved hearing device comprising a rotating hinge which provides room for other components e.g. a rechargeable battery without needing to increase the size of the earpiece.

It is another object of the invention to provide an improved hearing device comprising a rotating hinge which is arranged away from the centre of the earpiece while providing the required balanced pressure.

It is yet another object of the invention to provide an improved hearing device comprising a rotating hinge which allows for reducing the size of the earpiece while being compatible with some interface standards for wireless power transfer such as Qi standard.

It is yet another object of the invention to provide an improved hearing device e.g. a more stable hearing device.

Disclosed is a hearing device. The hearing device is configured to be worn by a user. The hearing device comprises an ear cup. The ear cup has a first surface. The first surface is configured to point towards the surroundings when the user is wearing the hearing device in its intended position. The hearing device further comprises a headband. The headband is configured to rest on the user's head. The headband has a first end and a second end. The hearing device further comprises a hinge arm. The hinge arm connects the ear cup to one of the first end or the second end of the headband. The hinge arm comprises a hinge center arranged at the earcup. The hinge center defines a rotating axis of the ear cup with respect to the headband. The hinge arm can rotate through an angular interval from a rest position to a variable use position. The hearing device further comprises a force element configured to bias the hinge arm towards the rest position, whereby the hinge arm maintains the rest position, when the hearing device is not worn by the user. The hinge center is arranged offset from a center of the ear cup. The rotating axis is configured to pass through the center of the ear cup.

It is an advantage that the hinge center is arranged offset from the center of the ear cup i.e. the hinge center is not configured to rotate at the center/middle of the ear cup. This is because, by arranging the hinge center offset from the center of the ear cup, the limited space in the centre/middle of the ear cup may be used for other purposes. For instance, other components such as a charging coil or a rechargeable battery for wireless charging may be arranged at the centre/middle of the ear cup instead of the hinge centre.

It is an advantage that the rotating axis is configured to pass through the center of the ear cup, as it provides the balanced pressure on the ear of a user, when the user is wearing the hearing device in its intended position. Thereby, although the hinge center is arranged offset from the center of the ear cup, the balanced pressure is still provided by configuring the rotating axis to pass through the center/middle of the ear cup. Thereby, the rotating axis which is configured to pass through the center of the ear cup provides an improved user experience e.g. comfort to the user of the hearing device, even when wearing the hearing device for a long period of time. It is an advantage that the force element is configured to bias the hinge arm towards the rest position, whereby the hinge arm maintains the rest position, when the hearing device is not worn by the user. This is because the force element allows for or at least facilitates the hinge arm maintaining the rest position. This in turn allows for providing a more stable hearing device e.g. a more stable hearing device for wireless charging that maintains its docking stable position when being wirelessly charged. This also allows for providing an improved user experience, as the hinge arm of the hearing device may not bulge on the first surface of the ear cup and/or may wobble less when the user holds the hearing device in her/his hand. The rest position may correspond to a position wherein the first surface of the ear cup rests on a surface e.g. on a charging pad.

In overall, the hearing device allows for decreasing a size of the ear cup of the hearing device. By the size of the ear cup is hereby meant a first dimension and a second dimension of the ear cup of the hearing device. The first dimension may extend parallel to the first surface of the ear cup. The ear cup may have a circular shape, an oval shape or another suitable shapes. In case of the circular shape, the first dimension may correspond to a diameter of the ear cup. The second dimension may extend perpendicular to the first surface of the ear cup. In other words, the second dimension may extend parallel to the normal surface of the first surface of the ear cup. In the case of the circular shape, the second dimension may correspond to a thickness of the ear cup. Thereby, the hearing device allows for decreasing both the diameter and the thickness of the ear cup of the hearing device. Thus, the hearing device allows for a more user-friendly hearing device e.g. a more portable and more convenient hearing device.

The hearing device may be any types of hearing devices which comprises an ear cup such as an over-the-ear and or an on-the-ear hearing device. The hearing device may comprise one ear cup. The hearing device may comprise a pair of ear cups i.e. two ear cups. The ear cup of the hearing device may be configured to partially or completely cover the ear of the user, when the user is wearing the hearing device in its intended position. The first dimension of the ear cup may be larger than the user's ear such that the ear cup may completely cover the user's ear. Alternatively, the first dimension of the ear cup may be smaller than the user's ear such that the ear cup may partially cover the user's ear.

The ear cup may have a second surface. The second surface may be arranged opposite to the first surface. The second surface may extend parallel to the first surface. The second surface may be covered by an ear cushion. The second surface may not be covered by an ear cushion. The ear cushion may be configured to partially or completely cover the user's ear, when the user is wearing the hearing device at its intended position. The ear cup may have at least one third surface. The at least one third surface may extend perpendicular to the first surface and the second surface of the ear cup. The at least one third surface may connect the first surface to the second surface. The at least one third surface may be a side surface of the ear cup.

The hinge center is arranged at the earcup. The hinge center may be arranged in the earcup. The hinge center may be arranged inside the earcup. The hinge center may be arranged in between the first surface and the second surface inside the ear cup. The hinge center defines the rotating axis of the ear cup with respect to the headband. The hinge center may allow for the rotation of the ear cup with respect to the headband in all directions. The hinge arm can rotate through an angular interval from the rest position to the variable use position. The rest position of the hinge arm may correspond to a position of the hinge arm when the hearing device is not worn by the user and is laying on a surface such as a wireless charging position. The variable use position of the hinge arm may correspond to all positions of the hinge arm when the hearing device is worn by the user e.g. all positions of the hinge arm corresponding to all positions of hearing device being worn by the user. The variable use position may e.g. be different for different users having different head shapes and sizes.

The hinge center is arranged offset from the center of the ear cup. In other words, there is a distance between the hinge center and the center of the ear cup. By the center of the ear cup is hereby meant a middle point of the ear cup. For instance, in the case of a circular ear cup, the center is the point that is equally distant from every point on the circumference of the circle. The force element may be any of or any combination of an elastic component such as a rubber, a spring e.g. a rotational spring, foam, gasket, or metal C-spring.

In an embodiment, a hearing device is configured to be worn by a user. The hearing device may be arranged at the user's ear, on the user's ear, over the user's ear, i.e., the hearing device is configured to be worn on, over and/or at the user's ear.

The hearing device may be a hearable such as a headset, headphone, earphone, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHz, preferably a wavelength between 900 MHz and 6 GHZ. The first frequency may be 902 MHz to 928 MHz. The first frequency may be 2.4 to 2.5 GHz.

The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment.

The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

In some embodiments, the first surface of the ear cup comprises a recess. The recess may be configured for at least partially receive the hinge arm. Thereby, the hinge arm may not bulge on/protrude/stick out of the first surface of the ear cup. The recess may extend into the ear cup i.e. towards the second surface of the ear cup. A size and a shape of the recess may respectively correspond to a size and a shape of the hinge arm. This may in turn allow for designing the hearing device and using the limited space of the ear cup of the hearing device in an efficient manner. For instance, the hinge arm may have a rectangular shape and the recess may also have a rectangular shape with a size corresponding to the size of the hinge arm.

In some embodiments, the hinge arm comprises a first part which is outside of the ear cup, and the hinge arm comprises a second part which is at the ear cup and flush with the first surface of the ear cup when the hinge arm is in the rest position. Thereby a continuous surface may be formed by the first surface of the ear cup and the second part of the hinge arm, received in the recess of the first surface, when the hinge arm is in the rest position. The first part of the hinge arm may connect the ear cup to one of the first end or the second end of the headband.

In some embodiments, at least a part of the first surface of the ear cup is substantially flat when the hinge arm is in the rest position. Thereby, a substantially flat surface may be formed by the at least a part of the first surface of the ear cup and the second part of the hinge arm, received in the recess of the first surface, when the hinge arm is in the rest position. The substantially flat surface allows for wireless charging of the hearing device on a charging pad. Thereby, the substantially flat surface allows for improving adding new functionalities or at least improving functionalities of the hearing device. The substantially flat surface may also improve aesthetic of the hearing device and may be desired.

In some embodiments, the hearing device comprises a rechargeable battery arranged inside the ear cup. The flat part of the first surface may provide that the ear cup is configured to be arranged on a charging pad for charging the rechargeable battery of the hearing device. Thereby, the rechargeable battery of the hearing device may be placed inside the ear cup without needing to increase the size of the ear cup e.g. the diameter of the ear cup. This is because the hinge center is arranged offset from the center of the ear cup and hence the center of the ear cup is not occupied by the hinge center. Thus, the arrangement of the hinge center provides room for the arrangement of the rechargeable battery inside the ear cup closer to the center of the ear cup, compared to the conventional ear cups. The rechargeable battery of the hearing device may be charged by arranging the flat part of the first surface of the ear cup on a charging pad. Alternatively or in addition, the hearing device may comprise a charging coil. The charging coil may similarly be arranged inside the ear cup without needing to increase the size of the ear cup e.g. the diameter of the ear cup. As mentioned above, the arrangement of the hinge center provides room for the arrangement of the charging coil inside the ear cup closer to the center of the ear cup, compared to the conventional ear cups. The charging coil may have a rectangular shape. A size of the charging coil may be 38 mm by 25 mm.

In some embodiments, an offset of the hinge center from the center of the ear cup is in the range of 10 to 20 mm such as 17 mm. The offset of the hinge center from the center of the ear cup provide rooms for e.g. the rechargeable battery or the charging coil without needing to increase the size of the ear cup e.g. the diameter of the ear cup. The offset may be 18 mm, 16 mm, 14 mm, or 12 mm.

In some embodiments, the hinge arm is arranged at a portion of the flat part of the first surface of the ear cup, the portion being in the range of 0.25% to 40% of the flat part of the first surface of the ear cup. By the hinge center being arranged offset from the center of the ear cup and the hinge arm being arranged at the portion, in the range of 25% to 40%, of the flat part of the first surface, the rest of the flat part of the first surface may be occupied by other components such as the rechargeable battery or the charging coil. In other word, 60% to 75% of the flat part of the first surface may be occupied by other components such as the rechargeable battery or the charging coil.

In some embodiments, the position of the hinge arm and the hinge center at the ear cup provide that the rechargeable battery in the ear cup is configured to be arranged substantially centrally in the ear cup for improving the recharging of the rechargeable battery. Thereby, the substantially centrally arrangement of the rechargeable battery in the ear cup may comply with the Qi interface standard for wireless power transfer. Thus, the hearing device may conveniently be charged when being placed on a Qi standard charger.

In some embodiments, the force element is arranged at the hinge arm. The force element may be arranged in the hinge arm. The force element may be arranged inside the hinge arm. The force element may be arranged in various ways. For instance, the force element may be arranged on a surface of the hinge arm facing the recess of the first surface of the ear cup. Another example, the force element may be a rotational spring arranged around a hinge tap. Alternatively or in combination, the force element may be arranged at the ear cup. For instance, force element may be arranged at/on a surface of the recess of the ear cup facing the hinge arm. The hearing device may comprise a force element. The hearing device may comprise a plurality of force elements. The plurality of the force elements may be arranged differently in the hearing device. For instance, one of the plurality of the force elements may be arranged at the hinge arm and another one of the plurality of the force elements may be arranged at the ear cup.

In some embodiments, the force element is arranged adjacent to the hinge center. There may be a distance between the force element and the hinge center. The distance may be in the ranged of 2.0 mm to 6.0 mm, such as 3.0 mm to 5.0 mm, such as 4.0 mm to 4.5 mm such as 4.3 mm.

In some embodiments, the force element is configured to provide that the hinge arm stays in the rest position when hearing device is not worn by the user. The force element may provide that the hinge arm stays in the rest position by compensating for forces that may be applied to the hearing when it is in the rest position. Thus, the hinge arm may stay in the rest position without bulging on/protruding/sticking out of the first surface of the ear cup. This in tun allows for providing a more stable hearing device e.g. a more stable hearing device for wireless charging that maintains its docking stable position when being wirelessly charged.

Typically, when the hearing device is in the rest position e.g. when the ear cup of the hearing device is arranged on a charging pad, a first torque may be created. The first torque may be created due to a center of gravity of the headband being arranged at one side of the ear cup and the ear cup itself. The first torque may have a first direction e.g. a clockwise direction. In the case of the clockwise torque, the first torque may apply a first force on the hinge arm to bulge on/protrude/stick out of the first surface of the ear cup. The hearing device may thus not maintain its docking position.

The inventive concept allows for the force element to be arranged such that it may create a second torque in a second direction opposite to the first direction. In the case of the first direction having a clockwise direction, the second torque may have an anti-clockwise direction. The second torque may be designed such that it may apply a second force on the hinge arm. The second force may have at least the same magnitude as the first force. Thus, the force element may cancel out forces which are applied to the hearing device in the rest position or may compensate for forces that may be applied to the hearing when it is in the rest position. Thus, the force element may allow for providing a more stable hearing device.

In some embodiments, the first part of the hinge arm is arranged to be connected to the second part of the hinge arm with an angle in the range of 120° to 150° such as 130°. The angle may facilitate providing an improved hearing device in terms of user-friendliness e.g. convenience. In some embodiments, the first part of the hinge arm is pivotably attached to the first end or the second end of the headband by means of a first pivot hinge. Thereby, an even distribution of a clamping force may be applied on the user's ear when the user is wearing the hearing device in its intended position.

The present invention relates to different aspects including the hearing device described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIGS. 1a and 1b schematically illustrate a front view and a side view of an exemplary ear cup 10 of a hearing device 100.

FIG. 2 schematically illustrates a front view of an exemplary ear cup 10 of a hearing device 100 comprising a rechargeable battery 40.

FIG. 3 schematically illustrates an exemplary hearing device 100 comprising a pair of ear cups 10, 10′.

FIGS. 4a and 4b schematically illustrate a perspective view of the ear cup 10 of the hearing device 100, shown in FIG. 3 in a rest position and a variable use position, respectively.

FIGS. 5a and 5b schematically illustrate an exemplary hearing device 100 in a rest position and a cross-sectional side view if the ear cup 10 of the hearing device 100, shown in FIG. 5a, respectively.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

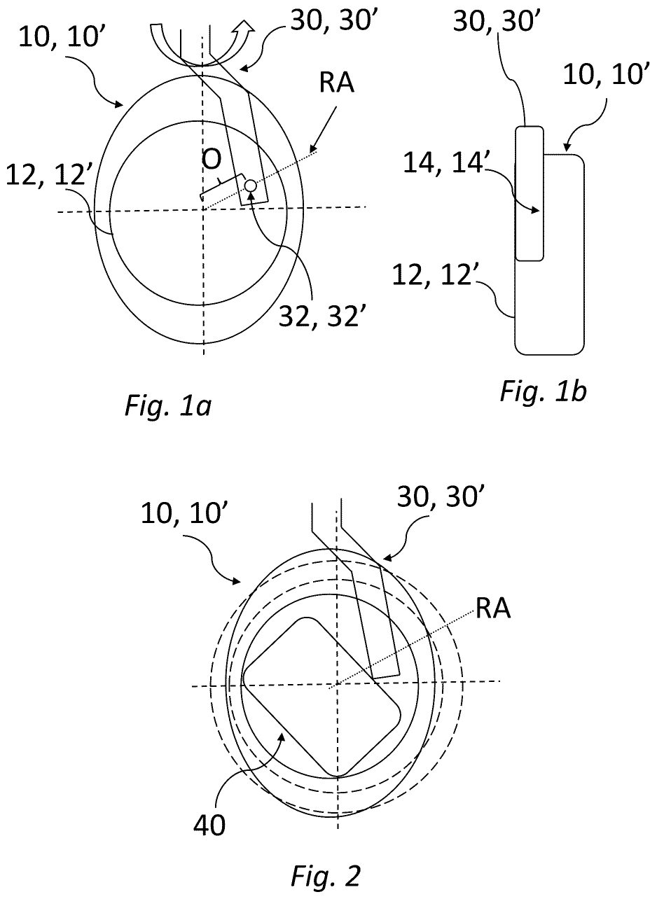

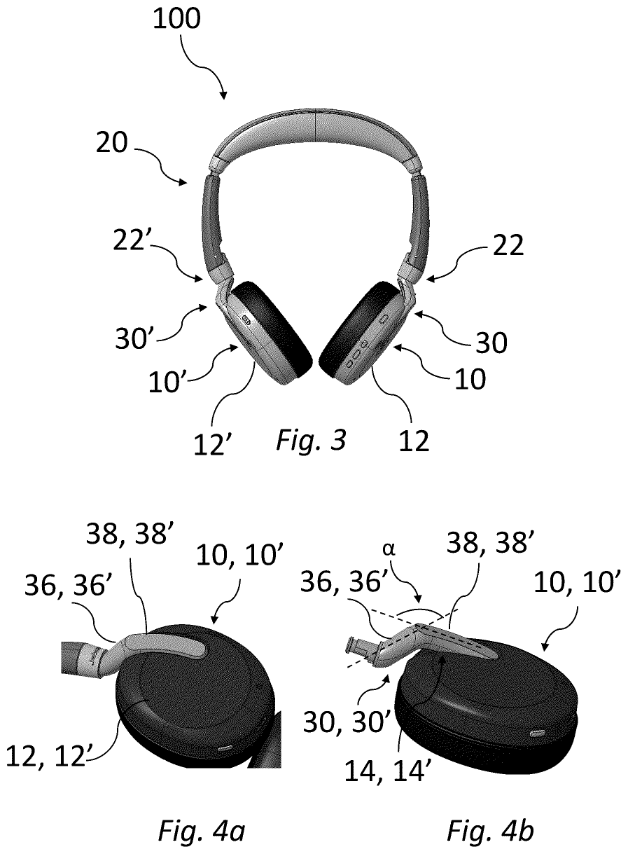

FIGS. 1a and 1b show a front view and a side view of an exemplary ear cup 10, 10′of a hearing device 100. FIG. 3 shows an exemplary hearing device 100. The hearing device 100 is configured to be worn by a user. The hearing device 100 comprises an ear cup 10, 10′. The hearing device 100 may comprise a pair of ear cups 10, 10′. The ear cup 10, 10′ has a first surface 12, 12′. The first surface 12, 12′ of the ear cup 10, 10′ is configured to point towards the surroundings when the user is wearing the hearing device 100 in its intended position.

FIG. 3 shows that the hearing device 100 further comprises a headband 20. The headband 20 is configured to rest on the user's head. The headband has a first end 22 and a second end 22′. The hearing device 100 further comprises a hinge arm 30, 30′ connecting the ear cup 10, 10′ to one of the first end 22 or the second end 22′ of the headband 20.

FIG. 1a shows that the hinge arm 30, 30′ comprises a hinge center 32, 32′. The hinge center 32, 32′ is arranged at the earcup 10, 10′. The hinge center 32, 32′ defines a rotating axis RA of the ear cup 10, 10′ with respect to the headband 20. The hinge arm 30, 30′ can rotate through an angular interval from a rest position to a variable use position. The rotating axis RA is configured to pass through the center of the ear cup 10, 10′. FIG. 1a shows that the hinge center 32, 32′ is arranged offset O from a center of the ear cup 10, 10′. The offset O of the hinge center 32, 32′ from the center of the ear cup 10, 10′ may be in the range of 10 to 20 mm such as 17 mm.

FIG. 1b shows that the first surface 12, 12′ of the ear cup 10, 10′ comprises a recess 14, 14′. The recess 14, 14′ may be configured for at least partially receiving the hinge arm 30, 30′.

FIGS. 4a and 4b show that the hinge arm 30, 30′ comprises a first part 36, 36′which is outside of the ear cup 10, 10′. FIGS. 4a and 4b further show that the hinge arm 30, 30′ comprises a second part 38, 38′ which is at the ear cup 10. FIG. 1b shows that the second part 38, 38′ flush with the first surface 12, 12′ of the ear cup 10, 10′ when the hinge arm 30, 30′ is in the rest position. The first part 36, 36′ of the hinge arm 30, 30′ may be arranged to be connected to the second part 38, 38′ of the hinge arm 30, 38′ with an angle α in the range of 120 °to 150 °. The first part 36, 36′ of the hinge arm 30, 30′may be pivotably attached to the first end 22 or the second end 22′of the headband 20 by means of a first pivot hinge.

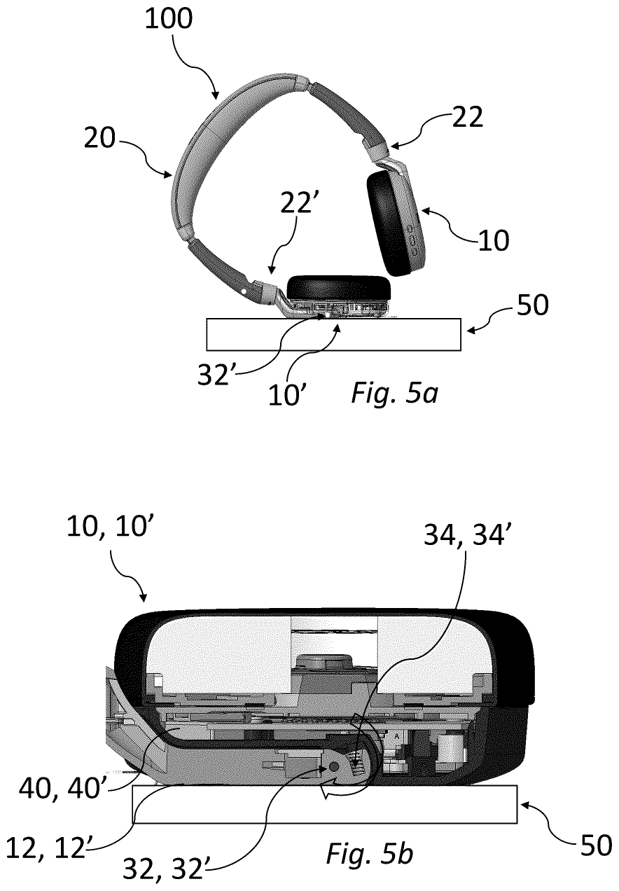

FIGS. 2, 5a and 5b show that the hearing device 100 comprises a rechargeable battery 40 arranged inside the ear cup 10, 10′. At least a part of the first surface 12, 12′ of the ear cup 10, 10′ may be substantially flat when the hinge arm 30, 30′ is in the rest position. The flat part of the first surface 12, 12′ may provide that the ear cup 10, 10′ is configured to be arranged on a charging pad 50 for charging the rechargeable battery 40 of the hearing device 100. The position of the hinge arm 30, 30′ and the hinge center 32, 32′ at the ear cup 10, 10′ ensures that there is place for a rechargeable battery that it relatively large compared to the size of the compact earcup 10, 10′. Furthermore, the area of the first surface 12, 12′ free of the hinge arm 30, 30′ ensures, that a charging coil can be arranged relatively centrally and have a size according to the Qi standard. The charging coil may have a rectangular shape, similar to the rechargeable battery 40 shown in FIG. 2. A size of the charging coil may be 38 mm by 25 mm.

FIGS. 1a and 2 shows that the hinge arm 30, 30′ is arranged at a portion of the flat part of the first surface 12, 12′ of the ear cup 10, 10′. The portion may be in the range of 0.25% to 40% of the flat part of the first surface 12, 12′ of the ear cup 10, 10′.

FIG. 5b further shows that the hearing device 100 further comprises a force element 34. The force element 34 may be configured to bias the hinge arm towards the rest position, whereby the hinge arm 30, 30′ may maintain the rest position, when the hearing device 100 is not worn by the user. The force element 34, 34′ may be arranged at the hinge arm 30, 30′. The force element 34, 34′ may be arranged adjacent to the hinge center 32, 32′. The force element 34, 34′may be configured to provide that the hinge arm 30, 30′ stays in the rest position when hearing device 100 is not worn by the user.

The hinge arm may be embodied as a yoke with two off-set hinge centers with a common radiation axis.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

1. A hearing device (100) configured to be worn by a user, the hearing device (100) comprising:
an ear cup (10, 10′) having a first surface (12, 12′), the first surface (12, 12′) being configured to point towards the surroundings when the user is wearing the hearing device (100) in its intended position,
a headband (20) being configured to rest on the user's head, the headband (20) having a first end (22) and a second end (22′),
a hinge arm (30, 30′) connecting the ear cup (10, 10′) to one of the first end (22) or the second end (22′) of the headband (20), the hinge arm (30, 30′) comprising:
a hinge center (32, 32′) arranged at the earcup (10, 10′), the hinge center (32, 32′) defining a rotating axis (RA) of the ear cup (10, 10′) with respect to the headband (20), whereby the hinge arm (30, 30′) can rotate through an angular interval from a rest position to a variable use position,
the hearing device (100) further comprising:
a force element (34) configured to bias the hinge arm towards the rest position, whereby the hinge arm (30, 30′) maintains the rest position, when the hearing device (100) is not worn by the user,
wherein the hinge center (32, 32′) is arranged offset (O) from a center of the ear cup (10, 10′), and wherein the rotating axis (RA) is configured to pass through the center of the ear cup (10, 10′). 2. The hearing device (100) according to item 1, wherein the first surface (12, 12′) of the ear cup (10, 10′) comprises a recess (14, 14′), the recess (14, 14′) being configured for at least partially receiving the hinge arm (30, 30′).

3. The hearing device (100) according to any of the preceding items, wherein the hinge arm (30, 30′) comprises a first part (36, 36′) which is outside of the ear cup (10, 10′), and wherein the hinge arm (30, 30′) comprises a second part (38, 38′) which is at the ear cup (10) and flush with the first surface (12, 12′) of the ear cup (10, 10′) when the hinge arm (30, 30′) is in the rest position.

4. The hearing device (100) according to item 2 or 3, wherein at least a part of the first surface (12, 12′) of the ear cup (10, 10′) is substantially flat when the hinge arm (30, 30′) is in the rest position.

5. The hearing device (100) according to item 4, wherein the hearing device (100) comprises a rechargeable battery (40) arranged inside the ear cup (10, 10′), and wherein the flat part of the first surface (12, 12′) provides that the ear cup (10, 10′) is configured to be arranged on a charging pad (50) for charging the rechargeable battery (40) of the hearing device (100).

6. The hearing device (100) according to any of the preceding items, wherein an offset (O) of the hinge center (32, 32′) from the center of the ear cup (10, 10′) is in the range of 10 to 20 mm such as 17 mm.

7. The hearing device (100) according to any of the preceding items, wherein the hinge arm (30, 30′) is arranged at a portion of the flat part of the first surface (12, 12′) of the ear cup (10, 10′), the portion being in the range of 0.25% to 40% of the flat part of the first surface (12, 12′) of the ear cup (10, 10′).

8. The hearing device (100) according to any of the preceding items, wherein the position of the hinge arm (30, 30′) and the hinge center (32, 32′) at the ear cup (10, 10′) provide that the rechargeable battery (40) in the ear cup (10, 10′) is configured to be arranged substantially centrally in the ear cup (10, 10′) for improving the recharging of the rechargeable battery (40).

9. The hearing device (100) according to any of the preceding items, wherein the force element (34, 34′) is arranged at the hinge arm (30, 30′).

10. The hearing device (100) according to any of the preceding items, wherein the force element (34, 34′) is arranged adjacent to the hinge center (32, 32′).

11. The hearing device (100) according to any of the preceding items, wherein the force element (34, 34′) is configured to provide that the hinge arm (30, 30′) stays in the rest position when hearing device (100) is not worn by the user.

12. The hearing device (100) according to any of the items 3-11, wherein the first part (36, 36′) of the hinge arm (30, 30′) is arranged to be connected to the second part (38, 38′) of the hinge arm (30, 38′) with an angle (a) in the range of 120 °to 150°.

13. The hearing device (100) according to any of the preceding items, wherein the first part (36, 36′) of the hinge arm (30, 30′) is pivotably attached to the first end (22) or the second end (22′) of the headband (20) by means of a first pivot hinge.
10, 10′ Ear cup
12, 12′ First surface of ear cup
14, 14′ Recess
20 Headband
22 First end of headband
22′ Second end of headband
30, 30′ Hinge arm
32, 32′ Hinge centre
34, 34′ Force element
36, 36′ First part of hinge arm
38, 38′ Second part of hinge arm
40 Rechargeable battery
50 Charging pad
RA Rotating axis
O Offset
α Angle
100 Hearing device

1. A hearing device configured to be worn by a user, the hearing device comprising:
an ear cup having a first surface, the first surface being configured to point towards the surroundings when the user is wearing the hearing device in its intended position,
a headband being configured to rest on the user's head, the headband having a first end and a second end,
a hinge arm connecting the ear cup to one of the first end or the second end of the headband, the hinge arm comprising:
a hinge center arranged at the earcup, the hinge center defining a rotating axis (RA) of the ear cup with respect to the headband, whereby the hinge arm can rotate through an angular interval from a rest position to a variable use position,
the hearing device further comprising:
a force element configured to bias the hinge arm towards the rest position, whereby the hinge arm maintains the rest position, when the hearing device is not worn by the user,
wherein the hinge center is arranged offset from a center of the ear cup, and wherein the rotating axis is configured to pass through the center of the ear cup.

2. The hearing device according to claim 1, wherein the first surface, of the ear cup comprises a recess, the recess being configured for at least partially receiving the hinge arm .

3. The hearing device according to claim 1, wherein the hinge arm comprises a first part which is outside of the ear cup, and wherein the hinge arm comprises a second part which is at the ear cup and flush with the first surface of the ear cup when the hinge arm is in the rest position.
4. The hearing device according to claim 2, wherein at least a part of the first surface of the ear cup is substantially flat when the hinge arm is in the rest position.
5. The hearing device according to claim 4, wherein the hearing device comprises a rechargeable battery arranged inside the ear cup, and wherein the flat part of the first surface provides that the ear cup is configured to be arranged on a charging pad for charging the rechargeable battery of the hearing device.

6. The hearing device according to claim 1, wherein an offset of the hinge center from the center of the ear cup is in the range of 10 to 20 mm such as 17 mm.

7. The hearing device according to claim 1, wherein the hinge arm is arranged at a portion of the flat part of the first surface of the ear cup the portion being in the range of 0.25% to 40% of the flat part of the first surface of the ear cup.

8. The hearing device according to claim 1, wherein the position of the hinge arm and the hinge center at the ear cup provide that the rechargeable battery in the ear cup is configured to be arranged substantially centrally in the ear cup for improving the recharging of the rechargeable battery.

9. The hearing device according to claim 1, wherein the force element is arranged at the hinge arm.

10. The hearing device according to claim 1, wherein the force element is arranged adjacent to the hinge center.

11. The hearing device according to claim 1, wherein the force element is configured to provide that the hinge arm stays in the rest position when hearing device is not worn by the user.

12. The hearing device according to claim 3, wherein the first part of the hinge arm is arranged to be connected to the second part of the hinge arm with an angle (α) in the range of 120° to 150°.

13. The hearing device according to claim 1, wherein the first part of the hinge arm is pivotably attached to the first end or the second end of the headband by means of a first pivot hinge.
